(19) United States
(12) Patent Application Publication
(10) Pub. No.: US 2025/0321691 A1
(43) Pub. Date: Oct. 16, 2025

(54) TECHNIQUES FOR TRANSFERRING DATA BETWEEN MEMORY DEVICES

(71) Applicant: Micron Technology, Inc., Boise, ID (US)

(72) Inventors: Jameer Mulani, Bangalore (IN); Qisong Lin, El Dorado Hills, CA (US); Amiya Banerjee, Bangalore (IN); Nitul Gohain, Bangalore (IN); Prasad Bylahalli Chandrashekara, Bangalore (IN)

(21) Appl. No.: 19/091,225

(22) Filed: Mar. 26, 2025

Related U.S. Application Data
(60) Provisional application No. 63/632,736, filed on Apr. 11, 2024.

(51) Int. Cl. G06F 3/06

(52) U.S. Cl. CPC G06F 3/0647; G06F 3/0604; G06F 3/0659; G06F 3/0683

(57) ABSTRACT

Methods, systems, and devices for techniques for transferring data between memory devices are described. A memory system may pre-fetch one or more subsets of data associated with the data transfer operation from a first die of the memory system and a second die of the memory system prior to initiating a programming operation on either die. For example, to perform a data folding operation for a set of data which includes a first subset of data stored to the first die and a second subset of data stored to the second die, the memory system may retrieve both the first subset from the first die and the second subset from the second die prior to performing a programming operation on either die.

### CROSS REFERENCE

The present application for patent claims priority to U.S. Patent Application No. 63/632,736 by Mulani et al., entitled “TECHNIQUES FOR TRANSFERRING DATA BETWEEN MEMORY DEVICES,” filed Apr. 11, 2024, which is assigned to the assignee hereof, and which is expressly incorporated by reference in its entirety herein.

### TECHNICAL FIELD

The following relates to one or more systems for memory, including techniques for transferring data between memory devices.

### BACKGROUND

Memory devices are widely used to store information in devices such as computers, user devices, wireless communication devices, cameras, digital displays, and others. Information is stored by programming memory cells within a memory device to various states. For example, binary memory cells may be programmed to one of two supported states, often denoted by a logic 1 or a logic 0. In some examples, a single memory cell may support more than two states, any one of which may be stored. To access the stored information, the memory device may read (e.g., sense, detect, retrieve, determine) states from the memory cells. To store information, the memory device may write (e.g., program, set, assign) states to the memory cells.

Various types of memory devices exist, including magnetic hard disks, random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), self-selecting memory, chalcogenide memory technologies, not-or (NOR) and not-and (NAND) memory devices, and others. Memory cells may be described in terms of volatile configurations or non-volatile configurations. Memory cells configured in a non-volatile configuration may maintain stored logic states for extended periods of time even in the absence of an external power source. Memory cells configured in a volatile configuration may lose stored states if disconnected from an external power source.

### BRIEF DESCRIPTION OF THE DRAWINGS

FIG. 1 shows an example of a system that supports techniques for transferring data between memory devices in accordance with examples as disclosed herein.

FIG. 2A shows an example of data layouts that support techniques for transferring data between memory devices in accordance with examples as disclosed herein.

FIG. 2B shows an example of a timing diagram that supports techniques for transferring data between memory devices in accordance with examples as disclosed herein.

FIG. 3 shows an example of a process that supports techniques for transferring data between memory devices in accordance with examples as disclosed herein.

FIG. 4 shows a block diagram of a memory system that supports techniques for transferring data between memory devices in accordance with examples as disclosed herein.

FIG. 5 shows a flowchart illustrating a method or methods that support techniques for transferring data between memory devices in accordance with examples as disclosed herein.

### DETAILED DESCRIPTION

Some memory systems may support high-density blocks of memory cells in which each memory cell may be configured to store multiple bits, such as a quad-level cell (QLC) block. Because the time used to program data to such blocks may be relatively long, a memory system may initially (e.g., as part of a host write operation) program data to a lower-density block of memory cells in which each memory cell may be configured to store a lesser quantity of bits, such as a single level cell (SLC) block, a multi-level cell (MLC) block, or a tri-level cell (TLC) block. The memory system may subsequently transfer the data to the higher-density block, for example as part of a folding operation. In some examples, a memory system may implement a multi-die (e.g., two die) architecture, and the memory system may store data (e.g., a set of pages) having sequential logical addresses (e.g., sequential logical block addresses (LBAs) across both dies. Thus, a data transfer operation for the data may include reading a respective subset of the data from each die and programming the respective subset to the other die. However, to meet latency metrics, a memory system may maintain at least one die to address one or more host write requests, and thus may perform the data transfer operation in parallel with performing a host write request, such as by programming one or pages of first data associated with a host write to a lower-density block on a first die concurrently with (e.g., at least partially overlapping with) programming one or more pages of second data associated with a data transfer operation to a higher-density block on a second die. In some examples, due to timing differences between programming data to a higher-density block and programming data to a lower-density block, such a method to perform host write operations and data transfer operation in parallel may result in reduced data rate, increased latency, or both.

As described herein, to concurrently perform a host write operation and a data transfer operation, a memory system may pre-fetch one or more subsets of data associated with the data transfer operation from a first die of the memory system and a second die of the memory system prior to initiating a programming operation on either die. For example, to perform a data folding operation for a set of data which includes a first subset of data (e.g., one or more first pages) stored to the first die and a second subset of data (e.g., one or more second pages) stored to the second die, the memory system may retrieve both the first subset from the first die and the second subset from the second die prior to performing a programming operation on either die. The memory system may buffer the data (e.g., at a memory system controller). Such a method may allow the memory system to program the second subset of data to the first die and perform a host write operation on the second die at least partially in parallel (e.g., at least partially overlapping with), and may allow the memory system to program the second subset of data to the second die without waiting for the first die to complete to the first portion of the data transfer operation. Accordingly, by prefetching the one or more subsets of data, the memory system may increase the data rate, and/or may improve latency, among other advantages.

In addition to applicability in memory systems as described herein, techniques for transferring data between memory devices may be generally implemented to improve the performance of various electronic devices and systems (including artificial intelligence (AI) applications, augmented reality (AR) applications, virtual reality (VR) applications, and gaming). Some electronic device applications, including high-performance applications such as AI, AR, VR, and gaming, may be associated with relatively high processing requirements to satisfy user expectations. As such, increasing processing capabilities of the electronic devices by decreasing response times, improving power consumption, reducing complexity, increasing data throughput or access speeds, decreasing communication times, or increasing memory capacity or density, among other performance indicators, may improve user experience or appeal. Implementing the techniques described herein may improve the performance of electronic devices by improving efficiency of concurrent host write operations and data transfer operations, which may decrease processing or latency times, improve response times, or otherwise improve user experience, among other benefits.

In addition to applicability in memory systems as described herein, techniques for transferring data between memory devices may be generally implemented to improve the sustainability of various electronic devices and systems. As the use of electronic devices has become even more widespread, the quantity of energy used and harmful emissions associated with production of electronic devices and device operation has increased. Further, the amount of waste (e.g., electronic waste) associated with disposal of electronic devices may also pose environmental concerns. Implementing the techniques described herein may improve the impact related to electronic devices by improving efficiency of concurrent host write operations and data transfer operations, which may extend the life of electronic devices and thereby reducing electronic waste, among other benefits.

Features of the disclosure are illustrated and described in the context of systems, devices, and circuits. Features of the disclosure are further illustrated and described in the context of data layouts, timing diagrams, processes, and flowcharts.

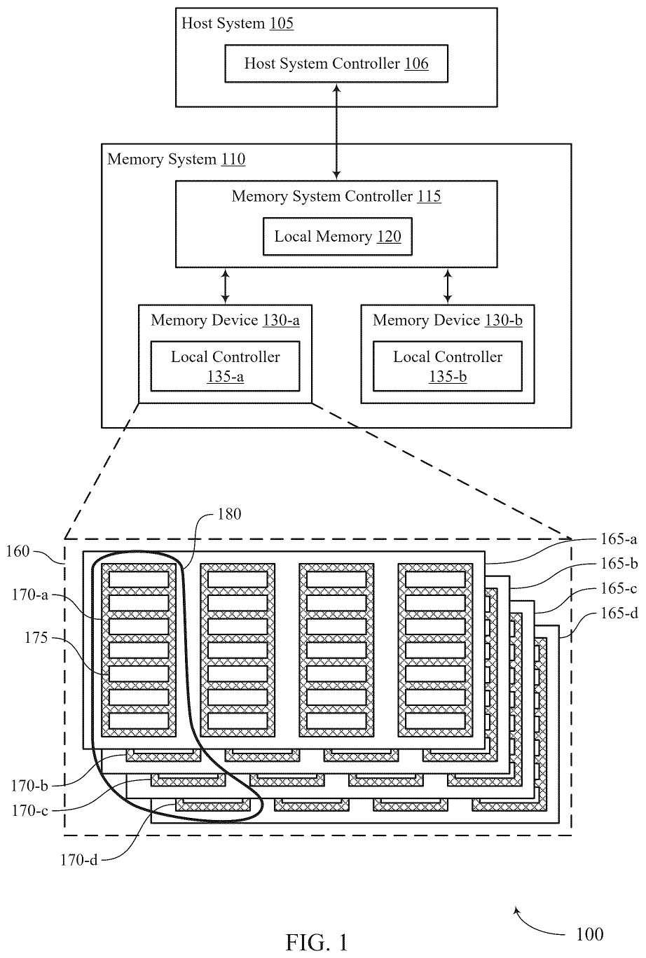

FIG. 1 shows an example of a system 100 that supports techniques for transferring data between memory devices in accordance with examples as disclosed herein. The system 100 includes a host system 105 coupled with a memory system 110. The system 100 may be included in a computing device such as a desktop computer, a laptop computer, a network server, a mobile device, a vehicle, an Internet of Things (IoT) enabled device, an embedded computer (e.g., one included in a vehicle, industrial equipment, or a networked commercial device), or any other computing device that includes memory and a processing device.

A memory system 110 may be or include any device or collection of devices, where the device or collection of devices includes at least one memory array. For example, a memory system 110 may be or include a Universal Flash Storage (UFS) device, an embedded Multi-Media Controller (eMMC) device, a flash device, a universal serial bus (USB) flash device, a secure digital (SD) card, a solid-state drive (SSD), a hard disk drive (HDD), a dual in-line memory module (DIMM), a small outline DIMM (SO-DIMM), or a non-volatile DIMM (NVDIMM), among other devices.

The system 100 may include a host system 105, which may be coupled with the memory system 110. In some examples, this coupling may include an interface with a host system controller 106, which may be an example of a controller or control component configured to cause the host system 105 to perform various operations in accordance with examples as described herein. The host system 105 may include one or more devices and, in some cases, may include a processor chipset and a software stack executed by the processor chipset. For example, the host system 105 may include an application configured for communicating with the memory system 110 or a device therein. The processor chipset may include one or more cores, one or more caches (e.g., memory local to or included in the host system 105), a memory controller (e.g., NVDIMM controller), and a storage protocol controller (e.g., peripheral component interconnect express (PCIe) controller, serial advanced technology attachment (SATA) controller). The host system 105 may use the memory system 110, for example, to write data to the memory system 110 and read data from the memory system 110. Although one memory system 110 is shown in FIG. 1, the host system 105 may be coupled with any quantity of memory systems 110.

The host system 105 may be coupled with the memory system 110 via at least one physical host interface. The host system 105 and the memory system 110 may, in some cases, be configured to communicate via a physical host interface using an associated protocol (e.g., to exchange or otherwise communicate control, address, data, and other signals between the memory system 110 and the host system 105). Examples of a physical host interface may include, but are not limited to, a SATA interface, a UFS interface, an eMMC interface, a PCIe interface, a USB interface, a Fiber Channel interface, a Small Computer System Interface (SCSI), a Serial Attached SCSI (SAS), a Double Data Rate (DDR) interface, a DIMM interface (e.g., DIMM socket interface that supports DDR), an Open NAND Flash Interface (ONFI), and a Low Power Double Data Rate (LPDDR) interface. In some examples, one or more such interfaces may be included in or otherwise supported between a host system controller 106 of the host system 105 and a memory system controller 115 of the memory system 110. In some examples, the host system 105 may be coupled with the memory system 110 (e.g., the host system controller 106 may be coupled with the memory system controller 115) via a respective physical host interface for each memory device 130 included in the memory system 110, or via a respective physical host interface for each type of memory device 130 included in the memory system 110.

The memory system 110 may include a memory system controller 115 and one or more memory devices 130. A memory device 130 may include one or more memory arrays of any type of memory cells (e.g., non-volatile memory cells, volatile memory cells, or any combination thereof). Although two memory devices 130-a and 130-b are shown in the example of FIG. 1, the memory system 110 may include any quantity of memory devices 130. Further, if the memory system 110 includes more than one memory device 130, different memory devices 130 within the memory system 110 may include the same or different types of memory cells.

The memory system controller 115 may be coupled with and communicate with the host system 105 (e.g., via the physical host interface) and may be an example of a controller or control component configured to cause the memory system 110 to perform various operations in accordance with examples as described herein. The memory system controller 115 may also be coupled with and communicate with memory devices 130 to perform operations such as reading data, writing data, erasing data, or refreshing data at a memory device 130—among other such operations—which may generically be referred to as access operations. In some cases, the memory system controller 115 may receive commands from the host system 105 and communicate with one or more memory devices 130 to execute such commands (e.g., at memory arrays within the one or more memory devices 130). For example, the memory system controller 115 may receive commands or operations from the host system 105 and may convert the commands or operations into instructions or appropriate commands to achieve the desired access of the memory devices 130. In some cases, the memory system controller 115 may exchange data with the host system 105 and with one or more memory devices 130 (e.g., in response to or otherwise in association with commands from the host system 105). For example, the memory system controller 115 may convert responses (e.g., data packets or other signals) associated with the memory devices 130 into corresponding signals for the host system 105.

The memory system controller 115 may be configured for other operations associated with the memory devices 130. For example, the memory system controller 115 may execute or manage operations such as wear-leveling operations, garbage collection operations, error control operations such as error-detecting operations or error-correcting operations, encryption operations, caching operations, media management operations, background refresh, health monitoring, and address translations between logical addresses (e.g., logical block addresses (LBAs)) associated with commands from the host system 105 and physical addresses (e.g., physical block addresses) associated with memory cells within the memory devices 130.

The memory system controller 115 may include hardware such as one or more integrated circuits or discrete components, a buffer memory, or a combination thereof. The hardware may include circuitry with dedicated (e.g., hard-coded) logic to perform the operations ascribed herein to the memory system controller 115. The memory system controller 115 may be or include a microcontroller, special purpose logic circuitry (e.g., a field programmable gate array (FPGA), an application specific integrated circuit (ASIC), a digital signal processor (DSP)), or any other suitable processor or processing circuitry.

The memory system controller 115 may also include a local memory 120. In some cases, the local memory 120 may include read-only memory (ROM) or other memory that may store operating code (e.g., executable instructions) executable by the memory system controller 115 to perform functions ascribed herein to the memory system controller 115. In some cases, the local memory 120 may additionally, or alternatively, include static random access memory (SRAM) or other memory that may be used by the memory system controller 115 for internal storage or calculations, for example, related to the functions ascribed herein to the memory system controller 115. Additionally, or alternatively, the local memory 120 may serve as a cache for the memory system controller 115. For example, data may be stored in the local memory 120 if read from or written to a memory device 130, and the data may be available within the local memory 120 for subsequent retrieval for or manipulation (e.g., updating) by the host system 105 (e.g., with reduced latency relative to a memory device 130) in accordance with a cache policy.

Although the example of the memory system 110 in FIG. 1 has been illustrated as including the memory system controller 115, in some cases, a memory system 110 may not include a memory system controller 115. For example, the memory system 110 may additionally, or alternatively, rely on an external controller (e.g., implemented by the host system 105) or one or more local controllers 135, which may be internal to memory devices 130, respectively, to perform the functions ascribed herein to the memory system controller 115. In general, one or more functions ascribed herein to the memory system controller 115 may, in some cases, be performed instead by the host system 105, a local controller 135, or any combination thereof. In some cases, a memory device 130 that is managed at least in part by a memory system controller 115 may be referred to as a managed memory device. An example of a managed memory device is a managed NAND (MNAND) device.

A memory device 130 may include one or more arrays of non-volatile memory cells. For example, a memory device 130 may include NAND (e.g., NAND flash) memory, ROM, phase change memory (PCM), self-selecting memory, other chalcogenide-based memories, ferroelectric random access memory (FeRAM), magneto RAM (MRAM), NOR (e.g., NOR flash) memory, Spin Transfer Torque (STT)-MRAM, conductive bridging RAM (CBRAM), resistive random access memory (RRAM), oxide based RRAM (OxRAM), electrically erasable programmable ROM (EEPROM), or any combination thereof. Additionally, or alternatively, a memory device 130 may include one or more arrays of volatile memory cells. For example, a memory device 130 may include RAM memory cells, such as dynamic RAM (DRAM) memory cells and synchronous DRAM (SDRAM) memory cells.

In some examples, a memory device 130 may include (e.g., on the same die, within the same package) a local controller 135, which may execute operations on one or more memory cells of the respective memory device 130. A local controller 135 may operate in conjunction with a memory system controller 115 or may perform one or more functions ascribed herein to the memory system controller 115. For example, as illustrated in FIG. 1, a memory device 130-a may include a local controller 135-a and a memory device 130-b may include a local controller 135-b.

In some cases, a memory device 130 may be or include a NAND device (e.g., NAND flash device). A memory device 130 may be or include a die 160 (e.g., a memory die). For example, in some cases, a memory device 130 may be a package that includes one or more dies 160. A die 160 may, in some examples, be a piece of electronics-grade semiconductor cut from a wafer (e.g., a silicon die cut from a silicon wafer). Each die 160 may include one or more planes 165, and each plane 165 may include a respective set of blocks 170, where each block 170 may include a respective set of pages 175, and each page 175 may include a set of memory cells.

In some cases, a NAND memory device 130 may include memory cells configured to each store one bit of information, which may be referred to as single level cells (SLCs). Additionally, or alternatively, a NAND memory device 130 may include memory cells configured to each store multiple bits of information, which may be referred to as multi-level cells (MLCs) if configured to each store two bits of information, as tri-level cells (TLCs) if configured to each store three bits of information, as quad-level cells (QLCs) if configured to each store four bits of information, or more generically as multiple-level memory cells. Multiple-level memory cells may provide greater density of storage relative to SLC memory cells but may, in some cases, involve narrower read or write margins or greater complexities for supporting circuitry.

In some cases, planes 165 may refer to groups of blocks 170 and, in some cases, concurrent operations may be performed on different planes 165. For example, concurrent operations may be performed on memory cells within different blocks 170 so long as the different blocks 170 are in different planes 165. In some cases, an individual block 170 may be referred to as a physical block, and a virtual block 180 may refer to a group of blocks 170 within which concurrent operations may occur. For example, concurrent operations may be performed on blocks 170-a, 170-b, 170-c, and 170-d that are within planes 165-a, 165-b, 165-c, and 165-d, respectively, and blocks 170-a, 170-b, 170-c, and 170-d may be collectively referred to as a virtual block 180. In some cases, a virtual block may include blocks 170 from different memory devices 130 (e.g., including blocks in one or more planes of memory device 130-a and memory device 130-b). In some cases, the blocks 170 within a virtual block may have the same block address within their respective planes 165 (e.g., block 170-a may be “block 0” of plane 165-a, block 170-b may be “block 0” of plane 165-b, and so on). In some cases, performing concurrent operations in different planes 165 may be subject to one or more restrictions, such as concurrent operations being performed on memory cells within different pages 175 that have the same page address within their respective planes 165 (e.g., related to command decoding, page address decoding circuitry, or other circuitry being shared across planes 165).

In some cases, a block 170 may include memory cells organized into rows (pages 175) and columns (e.g., strings, not shown). For example, memory cells in the same page 175 may share (e.g., be coupled with) a common word line, and memory cells in the same string may share (e.g., be coupled with) a common digit line (which may alternatively be referred to as a bit line).

For some NAND architectures, memory cells may be read and programmed (e.g., written) at a first level of granularity (e.g., at a page level of granularity, or portion thereof) but may be erased at a second level of granularity (e.g., at a block level of granularity). That is, a page 175 may be the smallest unit of memory (e.g., set of memory cells) that may be independently programmed or read (e.g., programed or read concurrently as part of a single program or read operation), and a block 170 may be the smallest unit of memory (e.g., set of memory cells) that may be independently erased (e.g., erased concurrently as part of a single erase operation). Further, in some cases, NAND memory cells may be erased before they can be re-written with new data. Thus, for example, a used page 175 may, in some cases, not be updated until the entire block 170 that includes the page 175 has been erased.

In some cases, to update some data within a block 170 while retaining other data within the block 170, the memory device 130 may copy the data to be retained to a new block 170 and write the updated data to one or more remaining pages of the new block 170. The memory device 130 (e.g., the local controller 135) or the memory system controller 115 may mark or otherwise designate the data that remains in the old block 170 as invalid or obsolete and may update a logical-to-physical (L2P) mapping table to associate the logical address (e.g., LBA) for the data with the new, valid block 170 rather than the old, invalid block 170. In some cases, such copying and remapping may be performed instead of erasing and rewriting the entire old block 170 due to latency or wearout considerations, for example. In some cases, one or more copies of an L2P mapping table may be stored within the memory cells of the memory device 130 (e.g., within one or more blocks 170 or planes 165) for use (e.g., reference and updating) by the local controller 135 or memory system controller 115.

In some cases, a memory system controller 115 or a local controller 135 may perform operations (e.g., as part of one or more media management algorithms) for a memory device 130, such as wear leveling, background refresh, garbage collection, scrub, block scans, health monitoring, or others, or any combination thereof. For example, within a memory device 130, a block 170 may have some pages 175 containing valid data and some pages 175 containing invalid data. To avoid waiting for all of the pages 175 in the block 170 to have invalid data in order to erase and reuse the block 170, an algorithm referred to as “garbage collection” may be invoked to allow the block 170 to be erased and released as a free block for subsequent write operations. Garbage collection may refer to a set of media management operations that include, for example, selecting a block 170 that contains valid and invalid data, selecting pages 175 in the block that contain valid data, copying the valid data from the selected pages 175 to new locations (e.g., free pages 175 in another block 170), marking the data in the previously selected pages 175 as invalid, and erasing the selected block 170. As a result, the quantity of blocks 170 that have been erased may be increased such that more blocks 170 are available to store subsequent data (e.g., data subsequently received from the host system 105).

In some cases, a memory system 110 may utilize a memory system controller 115 to provide a managed memory system that may include, for example, one or more memory arrays and related circuitry combined with a local (e.g., on-die or in-package) controller (e.g., local controller 135). An example of a managed memory system is a managed NAND (MNAND) system.

The system 100 may include any quantity of non-transitory computer readable media that support techniques for transferring data between memory devices. For example, the host system 105 (e.g., a host system controller 106), the memory system 110 (e.g., a memory system controller 115), or a memory device 130 (e.g., a local controller 135) may include or otherwise may access one or more non-transitory computer readable media storing instructions (e.g., firmware, logic, code) for performing the functions ascribed herein to the host system 105, the memory system 110, or a memory device 130. For example, such instructions, if executed by the host system 105 (e.g., by a host system controller 106), by the memory system 110 (e.g., by a memory system controller 115), or by a memory device 130 (e.g., by a local controller 135), may cause the host system 105, the memory system 110, or the memory device 130 to perform associated functions as described herein.

In some cases, to concurrently perform a host write operation and a data transfer operation, a memory system 110 may pre-fetch one or more subsets of data associated with the data transfer operation from a first die 160 of the memory system 110 and a second die 160 of the memory system prior to initiating a write operation on either die 160. For example, to perform a data folding operation for a set of data which includes a first subset of data (e.g., one or more first pages) stored to the first die 160 and a second subset of data (e.g., one or more second pages) stored to the second die 160, the memory system 110 may retrieve both the first subset from the first die 160 and the second subset from the second die 160 prior to performing a write operation on either die 160. The memory system 110 may buffer the data (e.g., at a memory system controller). Such a method may allow the memory system 110 to program the second subset of data to the first die 160 and perform a host write operation on the second die 160 at least partially in parallel, and may allow the memory system 110 to program the second subset of data to the second die 160 without waiting for the first die 160 to complete to the first portion of the data transfer operation. Accordingly, by prefetching the one or more subsets of data, the memory system 110 may increase the data rate, may improve latency, or both.

The system 100 may include any quantity of non-transitory computer readable media that support techniques for transferring data between memory devices. For example, the host system 105 (e.g., a host system controller 106), the memory system 110 (e.g., a memory system controller 115), or a memory device 130 (e.g., a local controller 135) may include or otherwise may access one or more non-transitory computer readable media storing instructions (e.g., firmware, logic, code) for performing the functions ascribed herein to the host system 105, the memory system 110, or a memory device 130. For example, such instructions, if executed by the host system 105 (e.g., by a host system controller 106), by the memory system 110 (e.g., by a memory system controller 115), or by a memory device 130 (e.g., by a local controller 135), may cause the host system 105, the memory system 110, or the memory device 130 to perform associated functions as described herein.

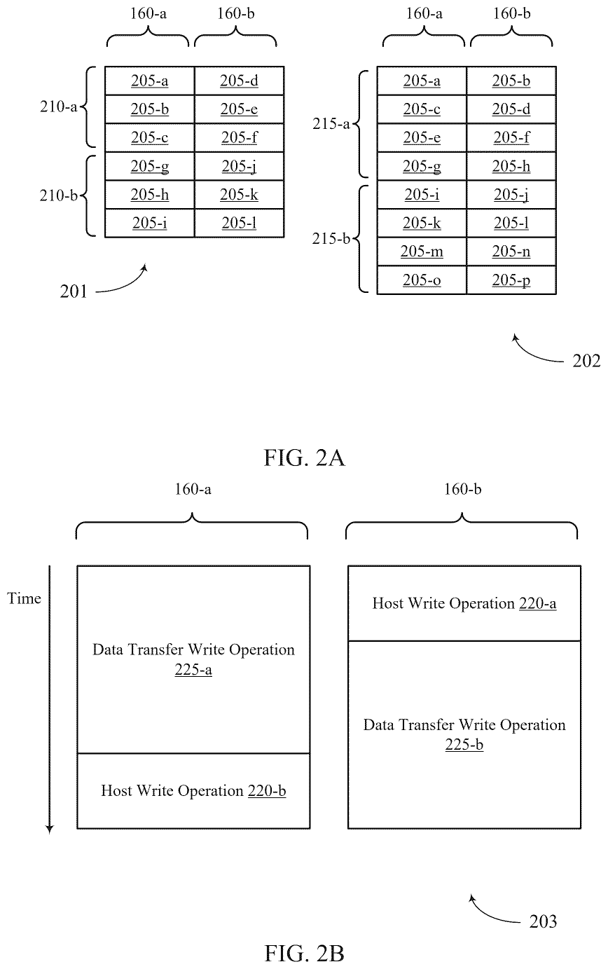

FIG. 2A shows examples of data layouts 201 and 202 that supports techniques for transferring data between memory devices in accordance with examples as disclosed herein. The data layouts 201 and 202 may illustrate one or more pages 205 of data stored at a memory system, such as the memory system 110 as described with reference to FIG. 1. The data layout 201 may illustrate data stored as part of a host write operation. As described herein, a host write operation may include receiving an access command and data (e.g., a write command to write one or more pages 205 of the data to the memory system) from a host system, such as the host system 105 as described with reference to FIG. 1, and programming the data to the memory system.

The memory system may support both high-density blocks of memory cells, such as QLC blocks, and low-density blocks of memory cells, such as SLC blocks, MLC blocks, TLC blocks, or a combination thereof. To improve the speed and efficiency of host write operations, the memory system may initially program data associated with a host write operation to one or more low-density blocks of memory cells. For example, as part of a host write operation, the memory system may program the pages 205 to one or more word lines 210 of low-density blocks within a die 160-a and a die 160-b of the memory system, such as a word line 210-a and a word line 210-b of one or more TLC blocks. Accordingly, each word line 210 of the block may store multiple (e.g., three) pages 205.

In some examples, the memory system may program the pages 205 according to a first order. For example, the pages 205-a through 205-1 may include a consecutive set of logical addresses (e.g., the logical addresses of the page 205-b may be consecutive the logical address of the page 205-a, the logical addresses of the page 205-c may be consecutive with the logical addresses of the page 205-c, and so on). To support efficient access of the pages 205 (e.g., sequential read operations, sequential write operations), the memory system may store the pages 205 across the dies 160, such that the pages 205-a, 205-b, and 205-c are programmed to a word line 210-a of the die 160-a, the pages 205-d, 205-e, and 205-f are programmed to a word line 210-a of the die 160-b, the pages 205-g, 205-h, and 205-i are programmed to a word line 210-b of the die 160-a, and the pages 205-j, 205-k, and 205-1 are programmed to a word line 210-b of the die 160-b. Such an order may be referred to as a “small-z” layout.

The memory system may transfer data from the one or more low-density blocks to one or more high-density blocks as part of a data transfer operation (e.g., a folding operation). For example, the memory system may transfer the pages 205 from the word lines 210 of the low-density blocks to one or more word lines 215 of high-density blocks within the die 160-a and 160-b, such as a word line 215-a and a word line 215-b of one or more QLC blocks. Accordingly, each word line 215 of the block may store multiple (e.g., four) pages 205.

In some cases, as part of the data transfer operation, the memory system may program the pages 205 according to a second order different than the first order. For example, the memory system may store the pages 205 across the dies 160, such that the pages 205-a, 205-c, 205-e, and 205-g are programmed to a word line 215-a of the die 160-a, the pages 205-b, 205-d, 205-f, and 205-h are programmed to a word line 21h-a of the die 160-b, the pages 205-i, 205-k, 205-m, and 205-o are programmed to a word line 215-b of the die 160-a, and the pages 205-j, 205-1, 205-n, and 205-p are programmed to a word line 215-b of the die 160-b. Such an order may be referred to as a “big-z” layout.

FIG. 2B shows an example of a timing diagram 203 that supports techniques for transferring data between memory devices in accordance with examples as disclosed herein. In some cases, to maintain latency metrics (e.g., to perform host write operations within a latency, such as a threshold period of time, from receiving a command associated with a host write operation), the memory system may perform a host write operation concurrently (e.g., at least partially in parallel) with data transfer operations. For example, the memory system may perform one or more write operations 225 associated with the data transfer operation on the die 160-a concurrently with performing one or more write operations 220 associated with a host write operation on the die 160-b (e.g., the write operation 220-a and the write operation 225-a my at least partially overlap in time). In some examples, the memory system may receive one or more write commands from a host system, and may schedule the one or more write commands to be performed as part of the write operations 220.

In some examples, a write operation 225 (e.g., programming one or more pages 205 to a word line 215) may occur is multiple stages or passes (e.g., using two-pass programming), while a write operation 220 (e.g., programming one or more pages to a word line 210) may occur in a single pass. Accordingly, the duration associated with a write operation 225 may be longer than a duration associated with a write operation 220. Additionally, due to the difference of the first order and the second order as described with reference to FIG. 2A, a data transfer operation may include reading a first subset of data from the die 160-a and writing the first subset of data to the die 160-b (e.g., transferring the pages 205-b, 205-g, or both from the die 160-a to the die 160-b) as well as reading a second subset of data from the die 160-b and writing the second subset of data to the die 160-a (e.g., transferring the pages 205-e, 205-k, or both from the die 160-b to the die 160-a).

To support an improved data rate associated with the data transfer operation while maintaining latency metrics associated with a host write operation, the memory system may pre-fetch data associated with the data transfer operation from the die 160-a and the die 160-b (for example) prior to initiating a write operation 220, a write operation 225, or both on either die 160 (the die 160-a or the die 160-b). For example, the write operation 225-a may include programming the pages 205-a, 205-c, 205-e, and 205-g to the word line 215-a of the die 160-a, and the write operation 225-b may include programming the pages 205-b, 205-d, 205-f, and 205-h to the word line 215-a of the die 160-b. Accordingly, prior to initiating the write operation 225-a, the memory system may read the pages 205-b and 205-h from the die 160-a and store the pages 205-b and 205-h to a buffer (e.g., may pre-fetch the pages 205), such as a buffer implemented by one or more controllers of the memory system (e.g., a memory system controller 115 as described with reference to FIG. 1). Additionally, the memory system may read the page 205-e from the die 160-b and store the page 205-e to the buffer.

After transferring the pages 205-b, 205-h and 205-e to the buffer, the memory system may initiate and perform the write operation 225-a on the die 160-a, and may perform the write operation 220-a on the die 160-b. The write operation 225-a may include transferring the pages 205-a, 205-c, and 205-g from the word line 210-a to the word line 215-a, as well as writing the page 205-e from the buffer to the word line 215-a. In some examples, after completing the write operation 225-a, the memory system may perform a write operation 220-b on the die 160-a. The write operation 220-b may correspond to writing data associated with a same write command as the write operation 220-a, or may correspond to writing data associated with a separate write command.

Because the memory system may pre-fetch the pages 205-b and 205-h (e.g., because the pages 205-b and 205-h may be transferred to the buffer before the die 160-a performs the write operation 225-a), the memory system may begin the write operation 225-b on the die 160-b after completing the write operation 220-a, without waiting to complete the write operation 225-a on the die 160-a. Accordingly, the memory system may improve the data rate by more efficiently scheduling the data transfer write operations 225, while maintaining or improving latency metrics associate with the host write operations 220, among other advantages.

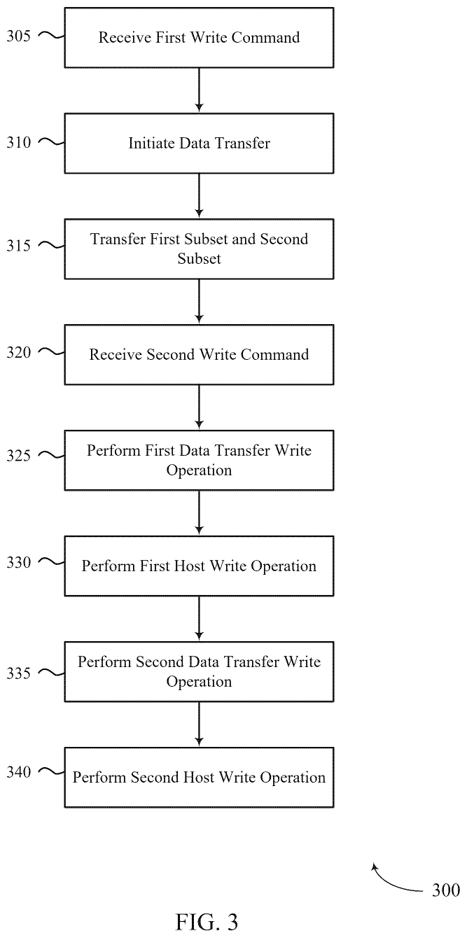

FIG. 3 shows an example of a process 300 that supports techniques for transferring data between memory devices in accordance with examples as disclosed herein. In some examples, a memory system, which may be an example of the memory system 110 implementing data layouts 201 and 202 and implementing a timing diagram 203 as described with reference to FIGS. 1, 2A, and 2B, may implement aspects of the process 300 using a memory system controller (e.g., a memory system controller 115). In the following description of process 300, the operations may be performed in a different order than the order shown. For example, specific operations may also be left out of process 300, or other operations may be added to process 300. Aspects of the process 300 may be implemented by one or more controllers, among other components. Additionally, or alternatively, aspects of the process 300 may be implemented as instructions stored in one or more memories (e.g., firmware stored in one or more memories, such as a memory device 130 or local memory 120 (or both), coupled with the memory system). For example, the instructions, if executed by one or more controllers (e.g., the memory system controller 115), may cause the one or more controllers (or a device or a system) to perform the operations of the process 300.

The process 300 may illustrate a data transfer operation to transfer one or more pages of data stored across a set of multiple dies from a first set of memory cells, such as one or more TLC blocks, to a second set of memory cells, such as one or more QLC blocks. In some examples, the one or more pages may be stored to first set of memory cells according to a first order (e.g., in accordance with a “small-z” layout) and may be stored to the second set of memory cells according to a second order different than the first order (e.g., in accordance with a “big-z” layout). The memory system may pre-fetch one or more subsets of the pages from a first die and a second die prior to beginning a write operation on either die. Additionally, the memory system may perform a host write operation concurrently with performing the data transfer operation.

By way of example, at 305, a write command may be received. For example, the memory system may receive a command to write first host data (e.g., data different than the data associated with the data transfer operation) to the memory system. In some examples, the memory system may buffer the write command prior to performing the write command, such as within a command queue of the memory system controller.

At 310, the data transfer operation may be initiated. The memory system may initiate the data transfer operation as part of background operations, such as garbage collection, wear leveling, or the like, or the memory system may initiate the data transfer operation in response to a command issued by the host system. As part of the data transfer operation, at 315, the memory system may transfer a first subset of the one or more pages from a first memory device (e.g., a first die) to a buffer of the memory system controller, and may transfer a second subset of the one or more pages from a second memory device (e.g., a second die) to the buffer.

In some examples, at 320, a second write command may be received. For example, the memory system may receive a command to write second host data to the memory system. In some examples, the memory system may buffer the second write command prior to performing the second write command, such as within the command queue of the memory system controller.

At 325 and 330, after transferring the first subset of pages and the second subset of pages to the buffer and 315, a first portion of the data transfer operation and a first host write operation may be performed. For example, the memory system may, at 325, perform a first data transfer write operation to write the second subset of pages to the first memory device. In some examples, performing the first data transfer write operation may include programming each page of the second subset of pages to a word line of the first memory device. Additionally, the memory system may, at 330, perform a first host write operation to write the first host data associated with the first write command received at 305 to the second memory device. In some examples, performing the first data transfer operation may at least partially overlap in time with performing the first host write operation.

At 335, a second data transfer write operation may be performed. For example, after completing the first host write operation on the second memory device at 330, the memory system may initiate and perform a second data transfer write operation to write the first subset of pages from the buffer to the second memory device. In some examples, performing the second data transfer write operation may include programming each page of the first subset of pages to a word line of the first memory device.

At 340, a second host write operation may be performed. For example, after completing the first data transfer write operation at 325, the memory system may write the second host data associated with the second write command received at 320 to the first memory device. In some examples, performing the second host write operation may at least partially overlap in time with performing the second data transfer write operation.

By pre-fetching both the first subset of pages and the second subset of pages before initiating the first data transfer write operation, the memory system may begin the second data transfer write operation without waiting to complete the first data transfer write operation, while maintaining at least one memory device to perform the first and second host write operations. Accordingly, the memory system may improve the data rate by more efficiently scheduling the data transfer write operations, while maintaining or improving latency metrics associate with the host write operations.

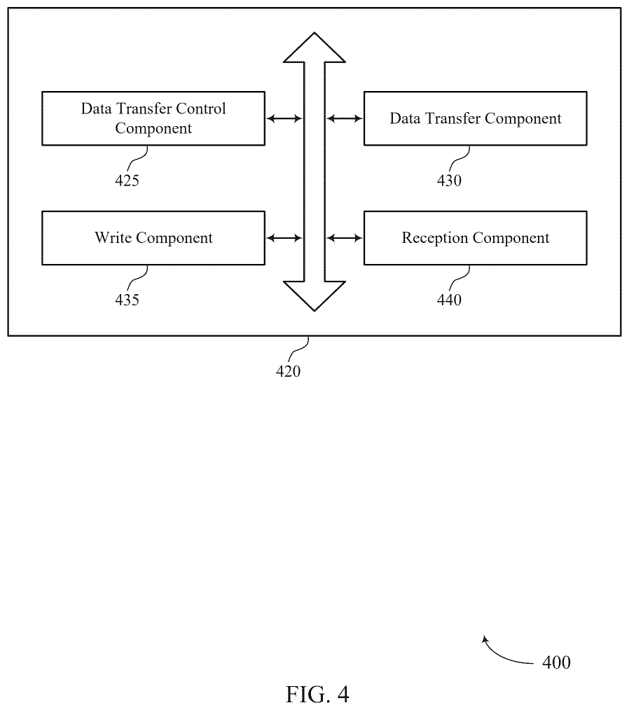

FIG. 4 shows a block diagram 400 of a memory system 420 that supports techniques for transferring data between memory devices in accordance with examples as disclosed herein. The memory system 420 may be an example of aspects of a memory system as described with reference to FIGS. 1 through 3. The memory system 420, or various components thereof, may be an example of means for performing various aspects of techniques for transferring data between memory devices as described herein. For example, the memory system 420 may include a data transfer control component 425, a data transfer component 430, a write component 435, a reception component 440, or any combination thereof. Each of these components, or components of subcomponents thereof (e.g., one or more processors, one or more memories), may communicate, directly or indirectly, with one another (e.g., via one or more buses).

The data transfer control component 425 may be configured as or otherwise support a means for initiating, at a memory system including processing circuitry and a plurality of memory devices coupled with the processing circuitry, a data transfer operation to transfer one or more pages of data from a plurality of first memory cells to a plurality of second memory cells, each second memory cell configured to store a second quantity of bits greater than a first quantity of bits that each first memory cell is configured to store. The data transfer component 430 may be configured as or otherwise support a means for transferring, as part of the data transfer operation, a first subset of the one or more pages from a first memory device of the plurality of memory devices to a buffer of the processing circuitry, the first subset for programming a second memory device of the plurality of memory devices, and a second subset of pages of the one or more pages from the second memory device to the buffer of the processing circuitry, the second subset for programming the first memory device. The write component 435 may be configured as or otherwise support a means for performing, as part of the data transfer operation, a write operation to write the first subset of pages to the first memory device after transferring the first subset of pages to the buffer and the second subset of pages to the buffer.

In some examples, the reception component 440 may be configured as or otherwise support a means for receiving,¬from a host device, a command to write second data to the memory system. In some examples, the write component 435 may be configured as or otherwise support a means for performing a second write operation based at least in part on writing the second data to the second memory device, where performing the write operation and performing the second write operation at least partially overlap in time.

In some examples, the write component 435 may be configured as or otherwise support a means for performing, as part of the data transfer operation, a second write operation to write the second subset of pages to the second memory device after transferring the first subset of pages to the buffer and the second subset of pages to the buffer.

In some examples, the reception component 440 may be configured as or otherwise support a means for receiving,¬from a host device, a command to write second data to the memory system. In some examples, the write component 435 may be configured as or otherwise support a means for performing a third write operation based at least in part on writing the second data to the first memory device, where performing the second write operation and performing the third write operation at least partially overlap in time.

In some examples, the write component 435 may be configured as or otherwise support a means for initiating the third write operation after performing the write operation.

In some examples, performing the write operation and performing the second write operation at least partially overlap in time.

In some examples, the write component 435 may be configured as or otherwise support a means for programming, as part of the data transfer operation, each page of the first subset of pages to a same word line of the first memory device.

In some examples, the one or more pages are stored at the plurality of first memory cells according to a first order, and the one or more pages are stored at the plurality of second memory cells according to a second order different than the first order.

In some examples, each first memory cell of the plurality of first memory cells is configured to store three bits of data, and each second memory cell of the plurality of second memory cells is configured to store four bits of data.

In some examples, the described functionality of the memory system 420, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the memory system 420, or various components thereof, may be implemented at least in part by instructions (e.g., stored in memory, non-transitory computer-readable medium) executable by such at least one processor.

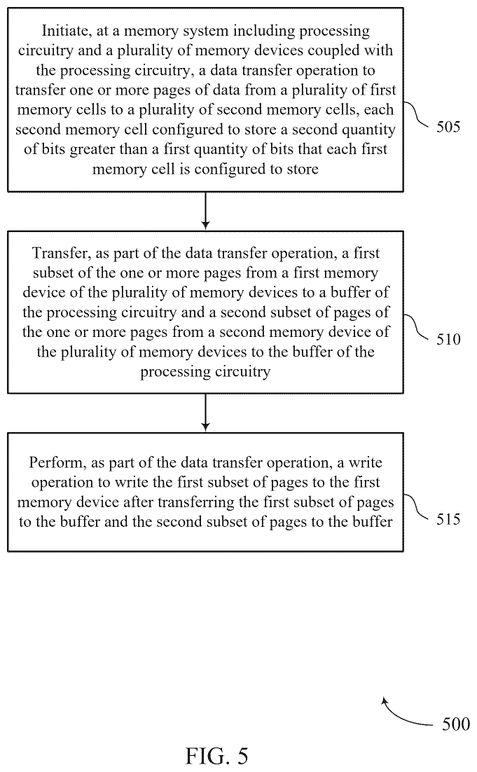

FIG. 5 shows a flowchart illustrating a method 500 that supports techniques for transferring data between memory devices in accordance with examples as disclosed herein. The operations of method 500 may be implemented by a memory system or its components as described herein. For example, the operations of method 500 may be performed by a memory system as described with reference to FIGS. 1 through 4. In some examples, a memory system may execute a set of instructions to control the functional elements of the device to perform the described functions. Additionally, or alternatively, the memory system may perform aspects of the described functions using special-purpose hardware.

At 505, the method may include initiating, at a memory system including processing circuitry and a plurality of memory devices coupled with the processing circuitry, a data transfer operation to transfer one or more pages of data from a plurality of first memory cells to a plurality of second memory cells, each second memory cell configured to store a second quantity of bits greater than a first quantity of bits that each first memory cell is configured to store. In some examples, aspects of the operations of 505 may be performed by a data transfer control component 425 as described with reference to FIG. 4.

At 510, the method may include transferring, as part of the data transfer operation, a first subset of the one or more pages from a first memory device of the plurality of memory devices to a buffer of the processing circuitry, the first subset for programming a second memory device of the plurality of memory devices, and a second subset of pages of the one or more pages from the second memory device to the buffer of the processing circuitry, the second subset for programming the first memory device. In some examples, aspects of the operations of 510 may be performed by a data transfer component 430 as described with reference to FIG. 4.

At 515, the method may include performing, as part of the data transfer operation, a write operation to write the first subset of pages to the first memory device after transferring the first subset of pages to the buffer and the second subset of pages to the buffer. In some examples, aspects of the operations of 515 may be performed by a write component 435 as described with reference to FIG. 4.

In some examples, an apparatus as described herein may perform a method or methods, such as the method 500. The apparatus may include features, circuitry, logic, means, or instructions (e.g., a non-transitory computer-readable medium storing instructions executable by a processor), or any combination thereof for performing the following aspects of the present disclosure:
Aspect 1: A method, apparatus, or non-transitory computer-readable medium including operations, features, circuitry, logic, means, or instructions, or any combination thereof for initiating, at a memory system including processing circuitry and a plurality of memory devices coupled with the processing circuitry, a data transfer operation to transfer one or more pages of data from a plurality of first memory cells to a plurality of second memory cells, each second memory cell configured to store a second quantity of bits greater than a first quantity of bits that each first memory cell is configured to store; transferring, as part of the data transfer operation, a first subset of the one or more pages from a first memory device of the plurality of memory devices to a buffer of the processing circuitry, the first subset for programming a second memory device of the plurality of memory devices, and a second subset of pages of the one or more pages from the second memory device to the buffer of the processing circuitry, the second subset for programming the first memory device; and performing, as part of the data transfer operation, a write operation to write the first subset of pages to the first memory device after transferring the first subset of pages to the buffer and the second subset of pages to the buffer.
Aspect 2: The method, apparatus, or non-transitory computer-readable medium of aspect 1, further including operations, features, circuitry, logic, means, or instructions, or any combination thereof for receiving,¬from a host device, a command to write second data to the memory system and performing a second write operation based at least in part on writing the second data to the second memory device, where performing the write operation and performing the second write operation at least partially overlap in time.
Aspect 3: The method, apparatus, or non-transitory computer-readable medium of any of aspects 1 through 2, further including operations, features, circuitry, logic, means, or instructions, or any combination thereof for performing, as part of the data transfer operation, a second write operation to write the second subset of pages to the second memory device after transferring the first subset of pages to the buffer and the second subset of pages to the buffer.
Aspect 4: The method, apparatus, or non-transitory computer-readable medium of aspect 3, further including operations, features, circuitry, logic, means, or instructions, or any combination thereof for receiving,¬from a host device, a command to write second data to the memory system and performing a third write operation based at least in part on writing the second data to the first memory device, where performing the second write operation and performing the third write operation at least partially overlap in time.
Aspect 5: The method, apparatus, or non-transitory computer-readable medium of aspect 4, further including operations, features, circuitry, logic, means, or instructions, or any combination thereof for initiating the third write operation after performing the write operation.
Aspect 6: The method, apparatus, or non-transitory computer-readable medium of any of aspects 3 through 5, where performing the write operation and performing the second write operation at least partially overlap in time.
Aspect 7: The method, apparatus, or non-transitory computer-readable medium of any of aspects 1 through 6, further including operations, features, circuitry, logic, means, or instructions, or any combination thereof for programming, as part of the data transfer operation, each page of the first subset of pages to a same word line of the first memory device.
Aspect 8: The method, apparatus, or non-transitory computer-readable medium of any of aspects 1 through 7, where the one or more pages are stored at the plurality of first memory cells according to a first order, and the one or more pages are stored at the plurality of second memory cells according to a second order different than the first order.
Aspect 9: The method, apparatus, or non-transitory computer-readable medium of any of aspects 1 through 8, where each first memory cell of the plurality of first memory cells is configured to store three bits of data, and each second memory cell of the plurality of second memory cells is configured to store four bits of data.

It should be noted that the described techniques include possible implementations, and that the operations and the steps may be rearranged or otherwise modified and that other implementations are possible. Further, portions from two or more of the methods may be combined.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (or in conductive contact with or connected with or coupled with) one another if there is any conductive path between the components that can, at any time, support the flow of signals between the components. At any given time, the conductive path between components that are in electronic communication with each other (or in conductive contact with or connected with or coupled with) may be an open circuit or a closed circuit based on the operation of the device that includes the connected components. The conductive path between connected components may be a direct conductive path between the components or the conductive path between connected components may be an indirect conductive path that may include intermediate components, such as switches, transistors, or other components. In some examples, the flow of signals between the connected components may be interrupted for a time, for example, using one or more intermediate components such as switches or transistors.

The term “coupling” (e.g., “electrically coupling”) may refer to a condition of moving from an open-circuit relationship between components in which signals are not presently capable of being communicated between the components over a conductive path to a closed-circuit relationship between components in which signals are capable of being communicated between components over the conductive path. If a component, such as a controller, couples other components together, the component initiates a change that allows signals to flow between the other components over a conductive path that previously did not permit signals to flow.

The term “isolated” refers to a relationship between components in which signals are not presently capable of flowing between the components. Components are isolated from each other if there is an open circuit between them. For example, two components separated by a switch that is positioned between the components are isolated from each other if the switch is open. If a controller isolates two components, the controller affects a change that prevents signals from flowing between the components using a conductive path that previously permitted signals to flow.

The terms “if,” “when,” “based on,” or “based at least in part on” may be used interchangeably. In some examples, if the terms “if,” “when,” “based on,” or “based at least in part on” are used to describe a conditional action, a conditional process, or connection between portions of a process, the terms may be interchangeable.

The devices discussed herein, including a memory array, may be formed on a semiconductor substrate, such as silicon, germanium, silicon-germanium alloy, gallium arsenide, gallium nitride, etc. In some examples, the substrate is a semiconductor wafer. In some other examples, the substrate may be a silicon-on-insulator (SOI) substrate, such as silicon-on-glass (SOG) or silicon-on-sapphire (SOP), or epitaxial layers of semiconductor materials on another substrate. The conductivity of the substrate, or sub-regions of the substrate, may be controlled through doping using various chemical species including, but not limited to, phosphorus, boron, or arsenic. Doping may be performed during the initial formation or growth of the substrate, by ion-implantation, or by any other doping means.

A switching component or a transistor discussed herein may represent a field-effect transistor (FET) and comprise a three terminal device including a source, drain, and gate. The terminals may be connected to other electronic elements through conductive materials, e.g., metals. The source and drain may be conductive and may comprise a heavily-doped, e.g., degenerate, semiconductor region. The source and drain may be separated by a lightly-doped semiconductor region or channel. If the channel is n-type (i.e., majority carriers are electrons), then the FET may be referred to as an n-type FET. If the channel is p-type (i.e., majority carriers are holes), then the FET may be referred to as a p-type FET. The channel may be capped by an insulating gate oxide. The channel conductivity may be controlled by applying a voltage to the gate. For example, applying a positive voltage or negative voltage to an n-type FET or a p-type FET, respectively, may result in the channel becoming conductive. A transistor may be “on” or “activated” if a voltage greater than or equal to the transistor's threshold voltage is applied to the transistor gate. The transistor may be “off” or “deactivated” if a voltage less than the transistor's threshold voltage is applied to the transistor gate.

The description set forth herein, in connection with the appended drawings, describes example configurations and does not represent all the examples that may be implemented or that are within the scope of the claims. The term “exemplary” used herein means “serving as an example, instance, or illustration” and not “preferred” or “advantageous over other examples.” The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Further, various components of the same type may be distinguished by following the reference label by a hyphen and a second label that distinguishes among the similar components. If just the first reference label is used in the specification, the description is applicable to any one of the similar components having the same first reference label irrespective of the second reference label.

The functions described herein may be implemented in hardware, software executed by a processing system (e.g., one or more processors, one or more controllers, control circuitry, processing circuitry, logic circuitry), firmware, or any combination thereof. If implemented in software executed by a processing system, the functions may be stored on or transmitted over as one or more instructions (e.g., code) on a computer-readable medium. Due to the nature of software, functions described herein can be implemented using software executed by a processing system, hardware, firmware, hardwiring, or combinations of any of these. Features implementing functions may be physically located at various positions, including being distributed such that portions of functions are implemented at different physical locations.

Illustrative blocks and modules described herein may be implemented or performed with one or more processors, such as a DSP, an ASIC, an FPGA, discrete gate logic, discrete transistor logic, discrete hardware components, other programmable logic device, or any combination thereof designed to perform the functions described herein. A processor may be an example of a microprocessor, a controller, a microcontroller, a state machine, or other types of processors. A processor may also be implemented as at least one of one or more computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read-only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk, and Blu-ray disc, where disks usually reproduce data magnetically, while discs reproduce data optically with lasers. Combinations of these are also included within the scope of computer-readable media.

The description herein is provided to enable a person skilled in the art to make or use the disclosure. Various modifications to the disclosure will be apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus, comprising:
processing circuitry associated with one or more memory devices and configured to cause the apparatus to:
initiate, at a memory system a plurality of memory devices coupled with the processing circuitry, a data transfer operation to transfer one or more pages of data from a plurality of first memory cells to a plurality of second memory cells, each second memory cell configured to store a second quantity of bits greater than a first quantity of bits that each first memory cell is configured to store;
transfer, as part of the data transfer operation, a first subset of pages of the one or more pages from a first memory device of the plurality of memory devices to a buffer of the processing circuitry, the first subset for programming a second memory device of the plurality of memory devices, and a second subset of pages of the one or more pages from the second memory device to the buffer of the processing circuitry, the second subset for programming the first memory device; and
perform, as part of the data transfer operation, a write operation to write the first subset of pages to the first memory device after transferring the first subset of pages to the buffer and the second subset of pages to the buffer.

2. The apparatus of claim 1, wherein the processing circuitry is further configured to cause the apparatus to:
receive, from a host device, a command to write second data to the memory system; and
perform a second write operation based at least in part on writing the second data to the second memory device, wherein performing the write operation and performing the second write operation at least partially overlap in time.

3. The apparatus of claim 1, wherein the processing circuitry is further configured to cause the apparatus to:
perform, as part of the data transfer operation, a second write operation to write the second subset of pages to the second memory device after transferring the first subset of pages to the buffer and the second subset of pages to the buffer.

4. The apparatus of claim 3, wherein the processing circuitry is further configured to cause the apparatus to:
receive, from a host device, a command to write second data to the memory system; and
perform a third write operation based at least in part on writing the second data to the first memory device, wherein performing the second write operation and performing the third write operation at least partially overlap in time.

5. The apparatus of claim 4, wherein the processing circuitry is further configured to cause the apparatus to:
initiate the third write operation after performing the write operation.

6. The apparatus of claim 3, wherein performing the write operation and performing the second write operation at least partially overlap in time.

7. The apparatus of claim 1, wherein the processing circuitry is further configured to cause the apparatus to:
program, as part of the data transfer operation, each page of the first subset of pages to a same word line of the first memory device.

8. The apparatus of claim 1, wherein the one or more pages are stored at the plurality of first memory cells according to a first order, and the one or more pages are stored at the plurality of second memory cells according to a second order different than the first order.

9. The apparatus of claim 1, wherein each first memory cell of the plurality of first memory cells is configured to store three bits of data, and each second memory cell of the plurality of second memory cells is configured to store four bits of data.

10. A non-transitory computer-readable medium storing code, the code comprising instructions executable by processing circuitry to:
initiate, at a memory system comprising the processing circuitry and a plurality of memory devices coupled with the processing circuitry, a data transfer operation to transfer one or more pages of data from a plurality of first memory cells to a plurality of second memory cells, each second memory cell configured to store a second quantity of bits greater than a first quantity of bits that each first memory cell is configured to store;
transfer, as part of the data transfer operation, a first subset of the one or more pages from a first memory device of the plurality of memory devices to a buffer of the processing circuitry, the first subset for programming a second memory device of the plurality of memory devices, and a second subset of pages of the one or more pages from the second memory device to the buffer of the processing circuitry, the second subset for programming the first memory device; and
perform, as part of the data transfer operation, a write operation to write the first subset of pages to the first memory device after transferring the first subset of pages to the buffer and the second subset of pages to the buffer.

11. The non-transitory computer-readable medium of claim 10, wherein the instructions are further executable by the processing circuitry to:
receive, from a host device, a command to write second data to the memory system; and
perform a second write operation based at least in part on writing the second data to the second memory device, wherein performing the write operation and performing the second write operation at least partially overlap in time.

12. The non-transitory computer-readable medium of claim 10, wherein the instructions are further executable by the processing circuitry to:
perform, as part of the data transfer operation, a second write operation to write the second subset of pages to the second memory device after transferring the first subset of pages to the buffer and the second subset of pages to the buffer.

13. The non-transitory computer-readable medium of claim 12, wherein the instructions are further executable by the processing circuitry to:
receive, from a host device, a command to write second data to the memory system; and
perform a third write operation based at least in part on writing the second data to the first memory device, wherein performing the second write operation and performing the third write operation at least partially overlap in time.

14. The non-transitory computer-readable medium of claim 13, wherein the instructions are further executable by the processing circuitry to:
initiate the third write operation after performing the write operation.

15. The non-transitory computer-readable medium of claim 12, wherein performing the write operation and performing the second write operation at least partially overlap in time.

16. The non-transitory computer-readable medium of claim 10, wherein the instructions are further executable by the processing circuitry to:
program, as part of the data transfer operation, each page of the first subset of pages to a same word line of the first memory device.

17. The non-transitory computer-readable medium of claim 10, wherein the one or more pages are stored at the plurality of first memory cells according to a first order, and the one or more pages are stored at the plurality of second memory cells according to a second order different than the first order.

18. The non-transitory computer-readable medium of claim 10, wherein each first memory cell of the plurality of first memory cells is configured to store three bits of data, and each second memory cell of the plurality of second memory cells is configured to store four bits of data.

19. A method, comprising:
initiating, at a memory system comprising processing circuitry and a plurality of memory devices coupled with the processing circuitry, a data transfer operation to transfer one or more pages of data from a plurality of first memory cells to a plurality of second memory cells, each second memory cell configured to store a second quantity of bits greater than a first quantity of bits that each first memory cell is configured to store;
transferring, as part of the data transfer operation, a first subset of the one or more pages from a first memory device of the plurality of memory devices to a buffer of the processing circuitry, the first subset for programming a second memory device of the plurality of memory devices, and a second subset of pages of the one or more pages from the second memory device to the buffer of the processing circuitry, the second subset for programming the first memory device; and
performing, as part of the data transfer operation, a write operation to write the first subset of pages to the first memory device after transferring the first subset of pages to the buffer and the second subset of pages to the buffer.

20. The method of claim 19, further comprising:
receiving, from a host device, a command to write second data to the memory system; and
performing a second write operation based at least in part on writing the second data to the second memory device, wherein performing the write operation and performing the second write operation at least partially overlap in time.

21. The method of claim 19, further comprising:
performing, as part of the data transfer operation, a second write operation to write the second subset of pages to the second memory device after transferring the first subset of pages to the buffer and the second subset of pages to the buffer.

22. The method of claim 21, further comprising:
receiving, from a host device, a command to write second data to the memory system; and
performing a third write operation based at least in part on writing the second data to the first memory device, wherein performing the second write operation and performing the third write operation at least partially overlap in time.

23. The method of claim 22, further comprising:
initiating the third write operation after performing the write operation.

24. The method of claim 21, wherein performing the write operation and performing the second write operation at least partially overlap in time.

25. The method of claim 19, further comprising:
programming, as part of the data transfer operation, each page of the first subset of pages to a same word line of the first memory device.
